(19) United States
(12) Patent Application Publication
(10) Pub. No.: US 2011/0280475 A1
(43) Pub. Date: Nov. 17, 2011

(54) APPARATUS AND METHOD FOR GENERATING BOKEH EFFECT IN OUT-FOCUSING PHOTOGRAPHY

(75) Inventors: Nitin SINGHAL, Suwon-si (KR); Ji-Hye Kim, Goyang-si (KR); Sung-Dae Cho, Yongin-si (KR)

(73) Assignee: Samsung Electronics Co., Ltd., Suwon-si (KR)

(21) Appl. No.: 13/106,323

(22) Filed: May 12, 2011

(30) Foreign Application Priority Data
May 12, 2010 (KR) 10-2010-0044458

(51) Int. Cl. G06K 9/40

(52) U.S. Cl. 382/162; 382/255

(57) ABSTRACT

An apparatus and method for out-focusing photography in a portable terminal is disclosed, including detecting a position of each pixel corresponding to a light area from an original image, generating a blurred image by blurring the original image, mapping a preset texture in correspondence with the detected positions of the pixels in the blurred image, and outputting a result image by mixing the image in which the texture is mapped and the original image, a user can perform out-focusing photography by using a portable terminal having a small lens iris.

### PRIORITY

This application claims priority under 35 U.S.C. §119 to an application filed in the Korean Intellectual Property Office on May 12, 2010 and assigned Serial No. 10-2010-0044458, the entire disclosure of which is incorporated herein by reference.

### BACKGROUND OF THE INVENTION

1. Field of the Invention

The present invention relates generally to an apparatus and method for out-focusing, and more particularly, to an apparatus and method for showing a Bokeh effect in out-focusing photography using a portable terminal equipped with a small camera lens.

2. Description of the Related Art

A photographing device is a device for recording and reproducing an image signal and a sound signal generated by photographing a subject on a recording medium through predetermined processing. Such a device can capture not only a still image but also moving images.

Examples of photographing devices are a camcorder, a digital camera, and a mobile communication terminal equipped with a digital camera.

When an image is captured by using such a photographing device, an appropriate blur effect on the background is the most important image effect for people looking at the image.

A camera lens may produce an effect, such as out-focusing, in which a background or a near field is less emphasized than a main subject.

Out-focusing is a method of concentrating attention on a subject by clearly photographing the subject with a correct focus on the subject and a background in an out-of-focus state. This method is mainly used to capture an image by focusing on a person or a specific subject.

Such an out-focusing effect can be obtained by capturing an image with a camera having a large lens iris, and in particular, such a camera having a large lens iris can show a Bokeh effect in an area influenced by light in out-focusing photography. The Bokeh effect is generally the way the lens renders out-of-focus points of light.

As described above, a conventional photographing device can perform out-focusing photography in which the Bokeh effect is shown on a background excluding a subject by using a large lens iris.

However, according to traditional methods, although out-focusing photography including the Bokeh effect can be performed by using only a photographing device with a large lens iris, out-focusing photography with the Bokeh effect cannot be performed by using a compact camera with a small lens iris including a camera of a portable terminal.

A photographing device having a small lens iris just shows an effect of smoothing an image but is unable to perform out-focusing photography including the Bokeh effect obtained by using a large lens iris.

### SUMMARY OF THE INVENTION

An aspect of the present invention is to substantially solve at least the above problems and/or disadvantages and to provide at least the advantages below. Accordingly, an aspect of the present invention is to provide an apparatus and method for showing a Bokeh effect in out-focusing photography with a portable terminal having a small lens iris.

According to an aspect of the present invention, an apparatus for out-focusing photography in a portable terminal is provided, the apparatus including: a light area position extractor for detecting a position of each pixel corresponding to a light area from an original image; an image effect processor for generating a blurred image by blurring the original image; a texture-mapping unit for mapping a preset texture in correspondence with the detected positions of the pixels in the blurred image; and an image-mixing unit for outputting a result image by mixing the image in which the texture is mapped and the original image.

According to another aspect of the present invention, a method for out-focusing photography in a portable terminal is provided, the method including: detecting a position of each pixel corresponding to a light area from an original image; generating a blurred image by blurring the original image; mapping a preset texture in correspondence with the detected positions of the pixels in the blurred image; and outputting a result image by mixing the image in which the texture is mapped and the original image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and advantages of the present invention will become more apparent from the following detailed description when taken in conjunction with the accompanying drawing in which:

FIG. 1 illustrates a photographing apparatus according to an embodiment of the present invention;

FIG. 2 is a flowchart illustrating a process of performing out-focusing photography in a photographing apparatus according to an embodiment of the present invention;

FIG. 3 illustrates a process of detecting a position of a light area in a light area position extractor according to an embodiment of the present invention;

FIG. 4 illustrates a process of mapping a texture to a detected position of a light area in a texture-mapping unit according to an embodiment of the present invention;

FIG. 5 illustrates a process of mixing an original image and an image output from the texture-mapping unit by using an Alpha map in an image-mixing unit according to an embodiment of the present invention; and

FIG. 6 illustrates a result image output from the photographing apparatus according to an embodiment of the present invention.

### DETAILED DESCRIPTION OF EMBODIMENTS OF THE PRESENT INVENTION

Embodiments of the present invention will be described herein below with reference to the accompanying drawings. Like reference numbers and symbols are used to refer to like elements through at the drawings. In the following description, well-known functions or constructions are not described in detail since they would obscure the invention with unnecessary detail.

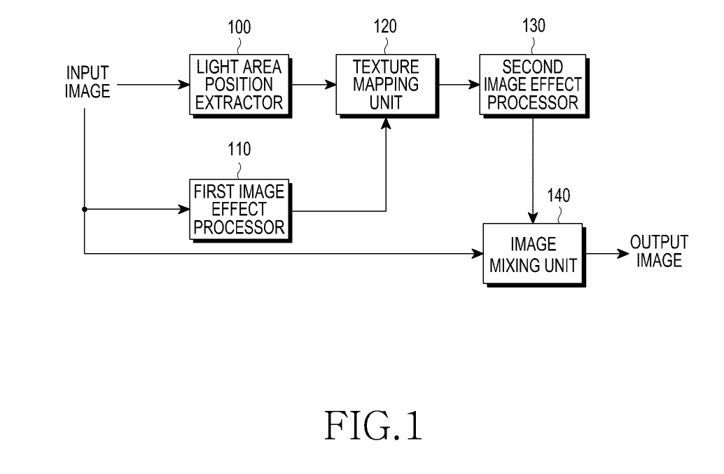

FIG. 1 is a block diagram of an apparatus for out-focusing operation according to an embodiment of the present invention.

A portable terminal according to an embodiment of the present invention includes a light area position extractor 100, a first image effect processor 110, a texture-mapping unit 120, a second image effect processor 130, and an image-mixing unit 140.

When an original image is input, the light area position extractor 100 checks a position of each pixel corresponding to a light area while scanning the pixels forming the input original image. The light area indicates an area consisting of pixels, having neighboring pixels with a larger pixel value surrounding each inner pixel.

In general, the light area position extractor 100 detects an area including pixels brighter or darker than neighboring pixels surrounding each pixel by using a blob extracting method and estimates the detected area as a light area.

The blob extracting method is a method of detecting an area including pixels brighter or darker than neighboring pixels surrounding each of the pixels.

In accordance with an embodiment of the present invention, each pixel is compared with neighboring pixels surrounding each pixel by using the blob extracting method, it is determined whether each pixel value difference is greater than a threshold, and an area including pixels having a pixel value difference greater than the threshold is determined to be a light area. The threshold may be a mean value of pixel value differences between each pixel and neighboring pixels surrounding each of the pixels.

The light area position extractor 100 then outputs position coordinates of each pixel corresponding to the determined light area.

The first image effect processor 110 applies an image effect, such as blur, to the input original image in order to show an effect, such as out-focusing. Blur refers to an effect of not clearly showing a subject even if the subject is correctly focused when capturing an image. Although a Gaussian blur effect is applied to show the effect, such as out-focusing, in the present invention, another effect for out-focusing besides blur may be applied.

The texture-mapping unit 120 maps a preset texture to the position of each pixel corresponding to the light area detected by the light area position extractor 100 in an image output from the first image effect processor 110 in order to show a Bokeh effect. The mapped texture may be any one of a plurality of figures or pictures previously selected by a user.

Further, the texture-mapping unit 120 may adjust the size of the mapped texture in proportion to the size of the original image when the texture is mapped. For example, if the size of the original image is 2000×1500 pixels, the texture size may be 30×30 pixels to 40×40 pixels.

Thereafter, the texture-mapping unit 120 sets a color value in an area of the mapped texture and the other area. The texture-mapping unit 120 sets a preset color value in the texture area and sets a color value corresponding to the original image in the other area.

The second image effect processor 130 applies the blur effect to only the area corresponding to the texture of the image, which is mapped by the texture-mapping unit 120, so that the mapped texture is shown naturally with the blurred image. The applied blur effect may be the Gaussian blur effect, and other various image effects may be applied.

The image-mixing unit 140 mixes the original image and the blurred image output from the second image effect processor 130 by using an Alpha map and outputs a result image.

Specifically, by using the Alpha map in which the original image is divided into a background area and a person area, the image-mixing unit 140 generates a result image in which the original image and the blurred image are mixed by mixing the blurred image output from the second image effect processor 130 on a position corresponding to the background area and mixing the original image on a position corresponding to the person area.

As described above, according to the present invention, an out-focusing image including the Bokeh effect may be generated by using a compact camera, such as a cellular phone camera.

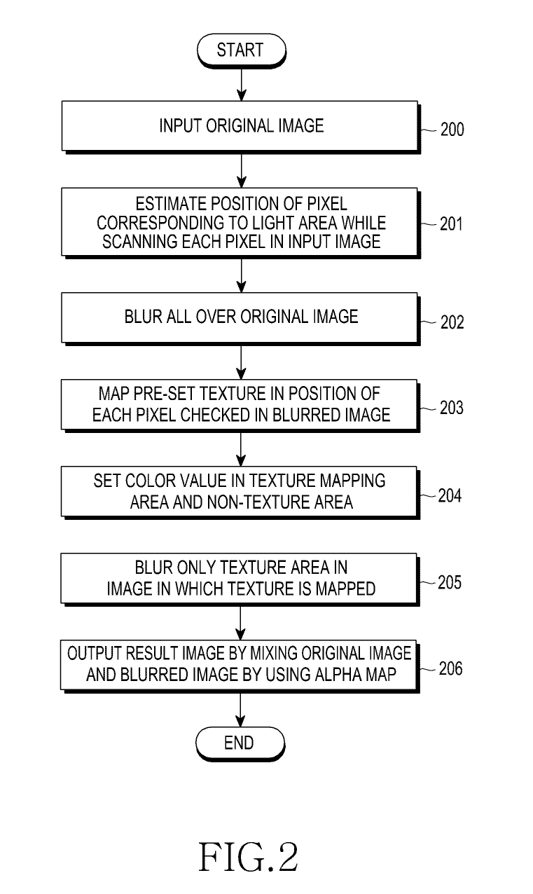

FIG. 2 is a flowchart of a process for out-focusing operation in a terminal according to the present invention.

If an original image is input in step 200, the light area position extractor 100 estimates a position of each pixel corresponding to a light area while scanning the pixels in the input original image one by one in step 201.

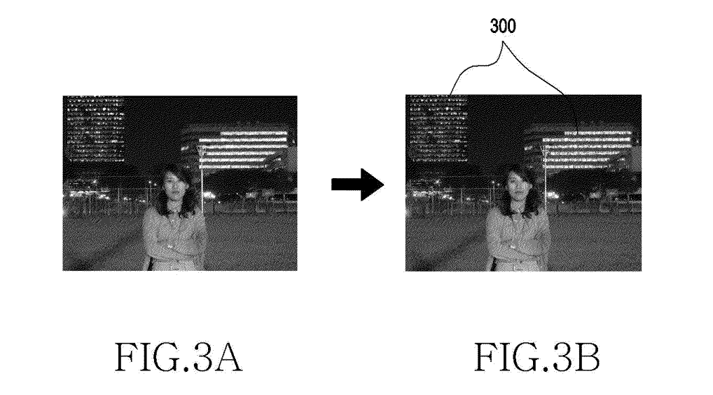

Specifically, the light area position extractor 100 checks pixels having a pixel value brighter than neighboring pixels by comparing a pixel value of each pixel with pixel values of neighboring pixels surrounding each pixel while scanning each pixel in the original image as shown in FIG. 3A and detects coordinates of the checked pixels. The checked pixels may correspond to an area denoted by reference numeral 300 in FIG. 3B.

The light area position extractor 100 determines whether a difference value between a pixel value each pixel and each pixel value of neighboring pixels surrounding each pixel is greater than the threshold value, and if it is determined that the difference is greater than the threshold value, checks a position of a pixel having the difference pixel value greater than the threshold.

The light area position extractor 100 may estimate position of pixels corresponding to the light area through various estimation methods, and, in particular, in the present invention, the light area position extractor 100 may use a blob estimation method.

In the current embodiment, the blob estimation method is performed using Equation 1.

$$G ( x , y , σ ) = {e}^{( - \frac{{x}^{2} + {y}^{2}}{2 {σ}^{2}} )} \\ H ( x , y , σ ) = \frac{( {x}^{2} + {y}^{2} - 2 {σ}^{2} ) G ( x , y , σ )}{2 π {σ}^{4} {\sum }_{x} {\sum }_{y} G ( x , y , σ )} \\ L ( x , y , σ ) = H ( x , y , σ ) * f ( x , y ) \\ {∇}^{2} L = {L}_{xx}^{2} + {L}_{yy}^{2} \qquad ( 1 )$$

where f(x, y) denotes an input image. The input image is convoluted by a scale Gaussian function H_(x, y, σ) with a specific scale σ for a scale spatial expression L (x, y, σ). In addition, H (x, y, σ) is obtained by normalizing a Gaussian function G (x, y, σ). The 2-dimensional Gaussian function G (x, y, σ) is used to reduce noise in the input image by smoothing.

Additionally, according to a Laplacian operator Δ²L, a result is usually calculated as a strong positive response to a dark blob and a strong negative response to a bright blob.

However, applying Δ²L at a single scale has some problems. Operator Δ²L response is strongly dependent on the relationship between the size of the blob in the image domain and the size of the Gaussian kernel used for smoothing. As a result, a multi-scale access is used to capture different-sized blobs. The Laplacian operator Δ²L is calculated for the scale σ within a range of [2, 18], in which a multi-scale operator is generated.

The selection of a blob point (\hat{x},ŷ) and a scale \hat{σ} is performed by Equation 2.

(\hat{x},ŷ,\hat{σ})=arg max local_{(x,y,σ)}(Δ²L) (2)

In step 202, the first image effect processor 110 blurs all over the input original image. The first image effect processor 110 performs blurring by using Equation 3.

$$g ( x , y , σ ) = \frac{{e}^{- \frac{( {x}^{2} + {y}^{2} )}{2 {σ}^{2}}}}{2 π {σ}^{2}} \\ {f}^{′} ( x , y ) = f ( x , y ) * g ( x , y , σ ) \qquad ( 3 )$$

When the input image f(x, y) is input, the input image is convoluted by a 2-dimensional Gaussian function g(x, y, σ) with the scale G to generate a smooth image f′(x, y). The 2-dimensional Gaussian function g(x, y, σ) is used to reduce noise in the input image by smoothing.

In step 203, the texture-mapping unit 120 maps a preset texture to the position of each pixel corresponding to the light area extracted in step 201 in the image blurred in step 202.

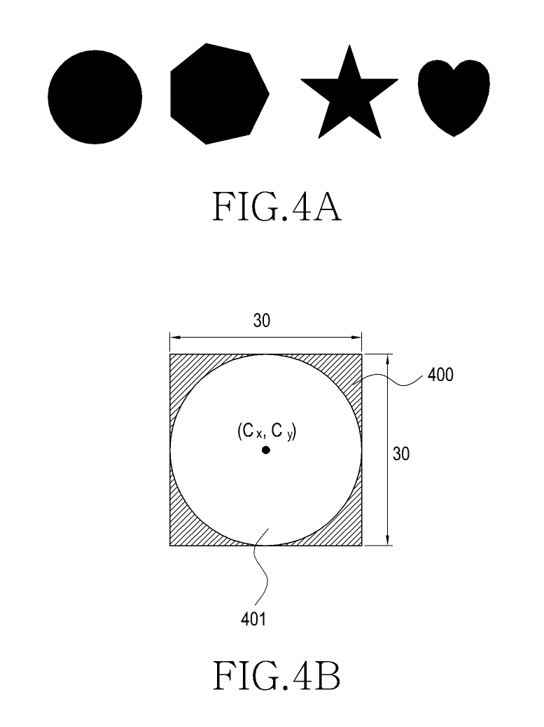

Specifically, the texture-mapping unit 120 maps a texture preset or selected by a user from among textures to be mapped to each pixel corresponding to the light area as shown in FIG. 4A in correspondence with a pixel corresponding to the position coordinates estimated by the light area position extractor 100.

For example, if the estimated position coordinates are (Cₓ, C_{y}) as shown in FIG. 4B, the texture-mapping unit 120 selects a mapping area having a size of 30×30 pixels to correspond to a texture on the position coordinates (Cₓ, C_{y}) and maps the texture to the selected area so that the texture is matched to the selected area. The texture can be selected or preset by the user and may have various patterns, such as a circle, heptagon, star, and heart as shown in FIG. 4A.

In step 204, the texture-mapping unit 120 sets a color value in the texture mapping area, in which the texture is mapped and sets a color value in the other area.

Specifically, the texture-mapping unit 120 determines whether a color value of each pixel in the selected mapping area as shown in FIG. 4B is 0. If the color value is 0, the texture-mapping unit 120 sets the corresponding pixel to a color value of the original image, and if the color value is not 0, the texture-mapping unit 120 sets the corresponding pixel to a color value obtained by mixing the color value of the original image and a color value of a specific color.

For example, if a color value of a non-texture area corresponding to reference numeral 400 is 0, the texture-mapping unit 120 sets the non-texture area to the color value of the original image, and if a color value of a texture area corresponding to reference numeral 401 is not 0, the texture-mapping unit 120 sets the texture area to a color value obtained by mixing the color value of the original image and a color value of a specific color.

In the above-described procedure, setting the color value obtained by mixing the color value of the original image and the color value of the specific color is to naturally show a color of the texture area with a color of a surrounding area.

The texture-mapping unit 120 sets the color value of the mapping area by using Equation 4.

$$T = T * {f}^{′} ( Cx , Cy ) \\ O\_block ( x , y ) = \{ \begin{matrix}α \cdot {f}^{ ′} \_block ( x , y ) + ( 1 - α ) \cdot T ( x , y ) , & if T ( x , y ) \neq 0 \\ {f}^{ ′} \_block ( x , y ) , & if T ( x , y ) = 0\end{matrix} \qquad ( 4 )$$

In equation (4), T denotes a mapping area including a texture, f′_block denotes an image area corresponding to the mapping area to correspond to the texture on (Cₓ, C_{y}) in a blurred image, and O_block denotes a mapping area of a result image in which the texture is mapped.

In step 205, the second image effect processor 130 processes a blur effect in only the texture mapping area in which the texture of the image generated in step 204 so that the texture mapping area is naturally expressed with its surrounding area.

In step 206, the image-mixing unit 140 mixes the original image and the image blurred by the second image effect processor 130 by using an Alpha map, in which a background area and a subject area are divided and outputs a result image.

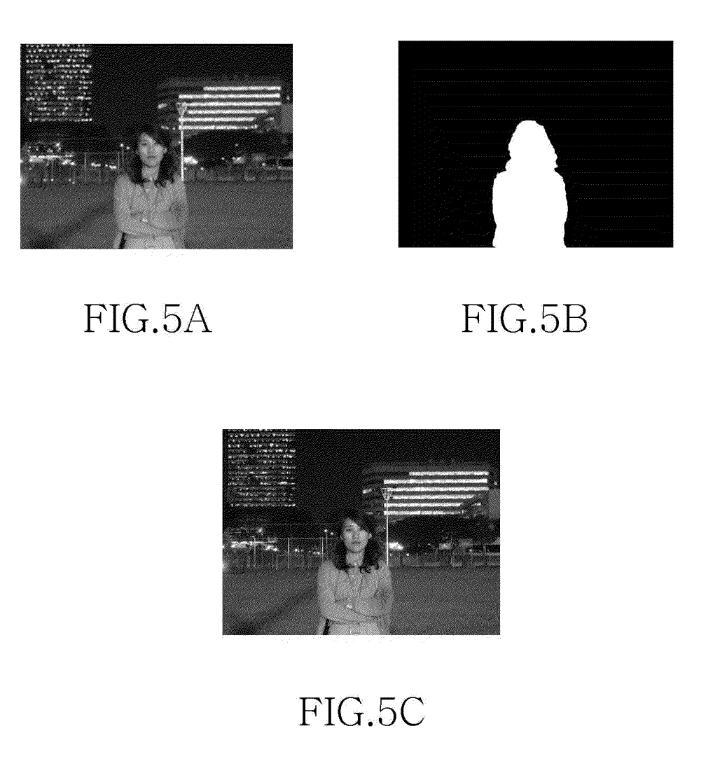

Specifically, by referring to an Alpha map in which the subject area is represented by “1” and the background area is represented by “0” as shown in FIG. 5B, the image-mixing unit 140 generates a result image by mixing an image corresponding to a subject area of the original image as shown in FIG. 5A in the subject area corresponding to “1” and mixing an image corresponding to a background area of the blurred image as shown in FIG. 5C in the background area corresponding to “0”.

In this case, the image-mixing unit 140 outputs the result image by using Equation 5.

f_outfocus=f_alpha·f+(1−f_alpha)·f_blur (5)

In equation 5, f_blur denotes an image blurred after texture mapping, f denotes an original image, f_alpha denotes an Alpha map image, which is acquired by manual selection or the use of a salient region map, and f_outfocus denotes an out-focused result image.

For example, the image-mixing unit 140 outputs f_blur as the result image if f_alpha is the subject area corresponding to “1” in the Alpha map image and outputs f as the result image if f_alpha is the background area corresponding to “0” in the Alpha map image.

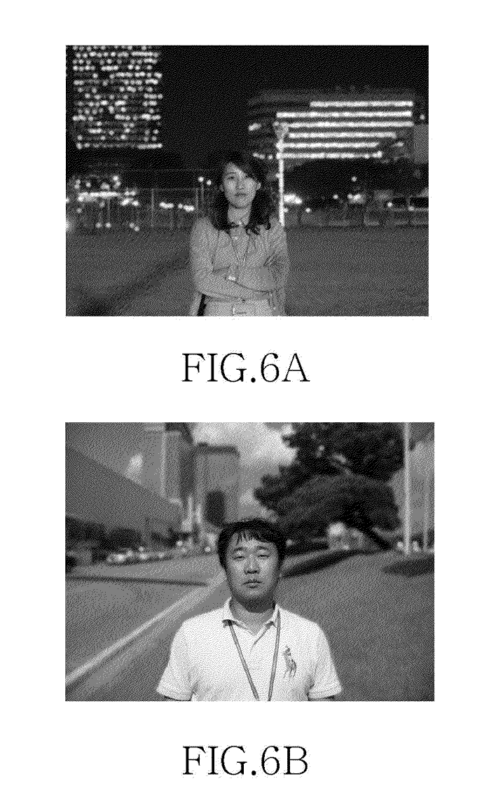

The result image output by the above-described process may be as shown in FIGS. 6A and 6B.

According to the present invention, by applying an out-focusing effect by mapping a preset texture in an area corresponding to a light area in an image captured with a camera having a small lens iris, an out-focusing capturing image including a Bokeh effect available in only a camera having a large lens iris can be generated.

While the invention has been shown and described with reference to certain embodiments thereof, it will be understood by those skilled in the art that various changes in form and details may be made therein without departing from the spirit and scope of the invention. Therefore, the spirit and scope of the present invention must be defined not by the described embodiments thereof but by the appended claims their equivalents.

What is claimed is:

1. An apparatus for generating a Bokeh effect in out-focusing photography, the apparatus comprising:
a light area position extractor for detecting a position of each pixel corresponding to a light area from an original image;
an image effect processor for generating a blurred image by blurring the original image;
a texture-mapping unit for mapping a preset texture in correspondence with the detected position of each pixel in the blurred image; and
an image-mixing unit for outputting a result image by mixing the image in which the texture is mapped and the original image.

2. The apparatus of claim 1, wherein the image effect processor blurs the texture in the image in which the texture is mapped.

3. The apparatus of claim 2, wherein
the light area position extractor calculates a difference value between a pixel value of each pixel of the original image and each pixel value of neighboring pixels surrounding each of the pixels,
determines whether the calculated difference value is greater than a threshold, and
estimates a position of a pixel having the difference value if the difference value is greater than the threshold.

4. The apparatus of claim 3, wherein the texture-mapping unit sets a mapping area of a preset size to map the texture on the detected position of each pixel and maps the texture in the set mapping area.

5. The apparatus of claim 4, wherein a size of the texture is set in proportion to a size of the original image.

6. The apparatus of claim 5, wherein the texture-mapping unit sets a color value of the mapped texture by mixing a preset color value and a color value of the original image corresponding to the texture.

7. The apparatus of claim 6, wherein the image-mixing unit outputs the result image by mixing an image area corresponding to a background area in the blurred image and an image area corresponding to a subject area in the original image by using an Alpha map in which the original image is divided into the background area and the subject area.

8. A method for generating a Bokeh effect in out-focusing photography, the method comprising:
detecting a position of each pixel corresponding to a light area from an original image;
generating a blurred image by blurring the original image;
mapping a preset texture in correspondence with the detected positions of the pixels in the blurred image; and
outputting a result image by mixing the image in which the texture is mapped and the original image.

9. The method of claim 8, further comprising:
blurring the texture in the image in which the texture is mapped.

10. The method of claim 9, wherein detecting of the position comprises:
calculating a difference value between a pixel value of each pixel of the original image and each pixel value of neighboring pixels surrounding each of the pixels;
determining whether the calculated difference value is greater than a threshold; and
estimating a position of a pixel having the difference value if the difference value is greater than the threshold.

11. The method of claim 10, wherein mapping the texture comprises:
setting a mapping area of a preset size to map the texture on the detected position of each pixel; and
mapping the texture in the set mapping area.

12. The method of claim 11, wherein a size of the texture is proportional to a size of the original image.

13. The method of claim 12, wherein the mapping of the texture further comprises:
setting a color value of the mapped texture by mixing a preset color value and a color value of the original image corresponding to the texture.

14. The method of claim 13, wherein outputting the result image comprises:
outputting the result image by mixing an image area corresponding to a background area in the blurred image and an image area corresponding to a subject area in the original image by using an Alpha map in which the original image is divided into the background area and the subject area.
